(19) United States
(12) Patent Application Publication
(10) Pub. No.: US 2012/0121849 A1
(43) Pub. Date: May 17, 2012

(54) AUTOMOBILE USE MAT WITH A DISTINGUISHED ANTI-SLIP FEATURE

(75) Inventor: Toru Nojima, Osaka (JP)

(73) Assignee: Suminoe Textile Co., Ltd., Osakashi (JP)

(21) Appl. No.: 13/293,640

(22) Filed: Nov. 10, 2011

(30) Foreign Application Priority Data
Nov. 12, 2010 (JP) 2010-253462

(51) Int. Cl. B32B 33/00; B32B 5/14

(52) U.S. Cl. 428/90; 428/156

(57) ABSTRACT

The challenges in this invention is to provide automobile use mat that has distinguished noise absorption and anti-slip features, as well as it being light in weight for a low cost.

The inventors, for their exerted investigations in resolving such challenges and as a result, as a replacement to the frequently used conventional mats with mounted resin (bump) emboss configuration, have introduced the nonwoven fabric layer from polypropylene fiber, burned on the lower surface side of the nonwoven fabric layer, deforming the fibers, forming anti-slip layer from melt bonding the fibers together, discovered the possibilities in achieving an automobile use mat that is light weight, permeable, dominant in its anti-slip effect, easy to bend as well as handle, that lead to this invention.

### TECHNICAL FIELD

This invention is regarding an automobile use mat which is to be used to cover the floor of an automobile interior, that is aimed for and has a distinguished sound-absorption function, anti-slip function, and furthermore is light weight.

### TECHNICAL BACKGROUND

Within an automobile floor, floor carpets are installed to increase comfort level when the feet is pressed towards the floor, and as a prevention to feeling any vibration coming from the floor. To prevent floor carpets from dirtying due to soil, sand, and mud, these mats are placed over it. When mats are stamped on, kicked, and/or if any other external force is applied to, it slides and moves over the floor carpet, moving out of its original place. As a prevention to such movement, the back side resin embossed (bump) mats are frequently used (see Patent Document 1).

Opposing to this, in recent years, are strongly needs to increase the silence level within the automobile interior environment in order to make automobile interior more comfortable. However with the currently used mats having an additional embossed resin layer, its permeability is distracted and effective sound absorption effect had not been achieved, therefore such needs were not satisfied. For this reason, product with a construction of nonwoven fabric molded to its back surface of the carpet's face material was introduced over the recent years (see Patent Document 2). A floor mat featured with an anti-slip cluster manufactured through a needle-punch process, and then utilizing the mat's back surface fiber of the nonwoven fabric which gets forced outward by taking it through the heat process is disclosed. Utilizing this construction, is believed to mainly absorb disturbing noises when noise pass through the nonwoven material layers, which provide appropriate noise absorption effect additional to the anti-slip effect.

Based on the Patent Document 3, the applicant additionally disclose automobile use mat which include also the noise absorption function together with its anti-slip function manufactured through heat processing the nonwoven fabric layer's lower surface which create numerous anti-slip clusters that are small in size.

### PRIOR ART DOCUMENTS

### Patent Documents

Patent Document 1: Japanese Unexamined Laid-open Patent Publication No. 2000-108753 (JP-2000-108753-A)
Patent Document 2: Japanese Unexamined Laid-open Patent Publication No. 2009-061992 (JP-2009-061992-A)
Patent Document 3: Japanese Unexamined Laid-open Patent Publication No. 2008-155865 (JP-2008-155865-A)

The mats as mentioned in Patent Reference 1 did not satisfy needs of reducing the product weight, and the mat as in Patent Reference 2 did not provide sufficient result in its anti-slip effect from the anti-slip clusters created by the needle-punch process. In addition, with floor mat mentioned in Patent Reference 3, the manufacturing process resulted in being complicated as well as the end product became hard and difficult to fold.

### SUMMARY OF THE INVENTION

### Problems To Be Solved By the Invention

This invention resulted from various technical backgrounds and expertise, that which enable to supply automobile use mat with distinguished noise absorption and anti-slip effect that is easy to fold and handle, as well as light weighted, manufactured at a very low cost.

### Means To Solve the Problems

As a result of the inventors' wholehearted investigations to resolve the faced challenges, instead of conventional mats often used, which is manufactured from resin/rubber material (bump), this invention of an automobile mat with high performance manufactured from polypropylene fiber nonwoven fabric layer, where its nonwoven fabric layer's lower surface is taken through burn process and its fiber/multiple fibers are deformed and bonded individually or together by melting the material, and this nonwoven layer fiber configuration is thicker at its top most edge compared to the fiber cross section, that which composes the anti-slip layer light in its weight, has good permeability and distinguished anti-slip feature, which is also easy to handle due to its flexible character, was achieved. This invention offers instrumentality as indicated below:

[1] An automobile use mat composed into a single material by layering the nonwoven fabric layer onto the face fabric materials' lower surface, as well as the nonwoven fabric mentioned earlier formed from polypropylene fiber over 1.5 dtex and no more than 30 dtex, as well as the lower side fiber of the nonwoven fabric layer previously mentioned is heat processed, where the fiber bond/fibers bonds together from melting, and this nonwoven layer fiber configuration is thicker at its top most edge compared to the fiber cross section, that create an anti-slip effect. This automobile use mat product is characterized by its distinguished anti-slip feature.

[2] An automobile use mat product as recited in the aforementioned Item 1, with a distinguished anti-slip feature containing hollow fiber within the polypropylene fiber mentioned earlier.

[3]This automobile use mat product as recited in the aforementioned Item 1 or Item 2, that has a distinguished anti-slip feature uses carpet with piles punched to its scrim for the above mentioned face fabric material layer, as well as the previously mentioned face material layer and the nonwoven fabric layer is formed into mats weighing 500˜900 g/m² (after drying) by using backing resin and filling the permeability adhesion resin layer which adhesively bonds the materials.

[4]This automobile use mat product as recited in the aforementioned Item 1 or Item 2, with a distinguished anti-slip feature manufactured from carpet material with pile punched to the scrim and for the face fabric layer mentioned earlier, a pre-coating process is applied to its lower surface of the scrim. This mat contains face material layer and nonwoven fabric layer earlier mentioned, and is formed into 100˜500 g/m² weight mat from melting the thermoplastic resin powder by applying heat which fills the permeable adhesive resin layer that which adhesively bonds materials.

### Effect of the Invention

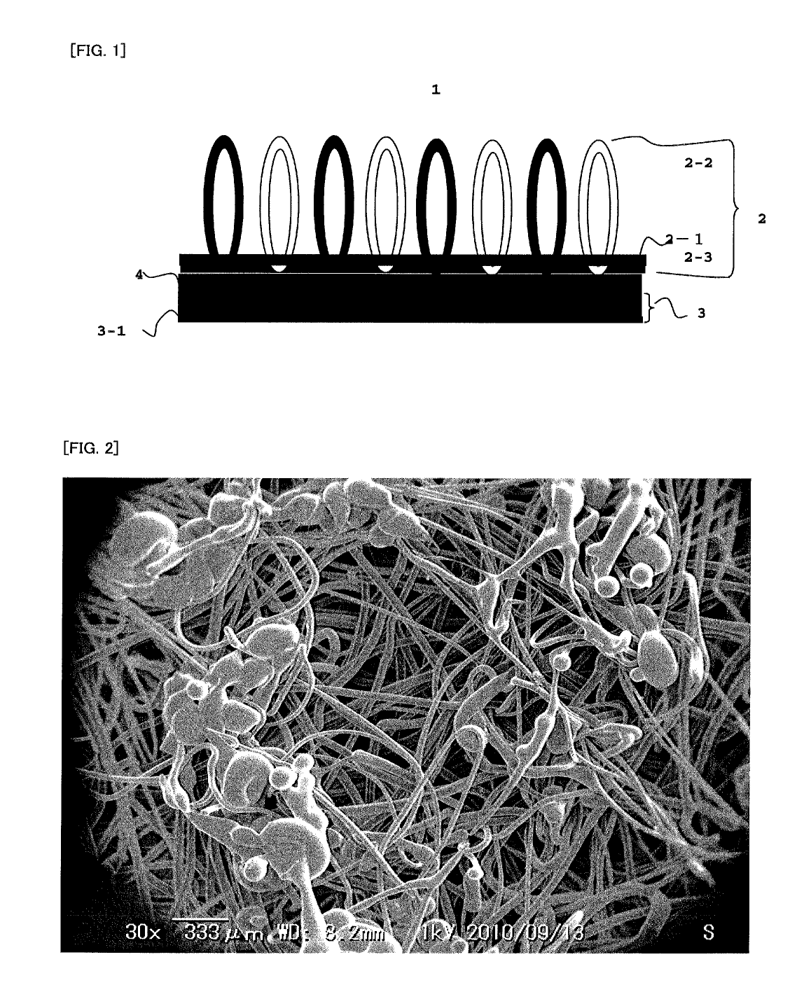

According to the invention [1], as this automobile use mat composed into a single material by layering the nonwoven fabric layer onto the face fabric materials' lower surface as well as with the nonwoven fabric mentioned earlier formed from polypropylene fiber over 1.5 dtex and no more than 30 dtex, it can demonstrate noise absorption effect for noises within both low and high frequency range. In addition, as this polypropylene fiber nonwoven fabric layer mentioned earlier is heat processed on its lower surface, the polypropylene fibers of the nonwoven fabric's lower surface bonds with the melting process by deforming each of the individual fibers or by bonding the fibers together through the melting process, the fiber's configuration tends to be thicker at the edges than at the cross section of the fiber (refer FIGS. 1, and 2), allowing entanglement to the fibers of the floor carpet surface, creating a greater friction resistance, and forming a high performance anti-slip layer. In addition, as it is a nonwoven fabric layer, compared to the automobile use mats manufactured from resin/rubber (bump) emboss, the anti-slip layer weight is reduced by ⅕ to 1/10.

According to the invention [2], the polypropylene fiber earlier mentioned contain hollow fiber therefore the hollow fibers as compared to other polypropylene fibers (solid fiber) melt down and deform easier not only at the ends but also the back sides of the fibers in a complex configuration, as a result forming a distinguished anti-slip layer that which entangles to the fibers of the floor carpet surface, creating a greater friction resistance.

According to the invention [3], it utilizes carpet material for its surface material with which piles are punched into the scrim, as well as for the face material layer and the nonwoven fabric layer mentioned earlier is formed into mats weighing 500˜900 g/m² (after drying) by using backing resin and filling the permeability adhesion resin layer which adhesively bonds the materials, enabling sufficient stitch removal strength, has good firmness as an automobile use mat, while assuring permeability and bonding strength throughout the entire automobile use mat, deploys noise absorption and anti-slip capabilities, and promotes automobile use mat light in its weight.

According to the invention [4], it utilizes carpet material for its surface material with which piles are punched into the scrim, as well as a pre-coat process is applied on the scrim lower surface, in which this allows it to be an automobile use mat with sufficient stitch removal strength, and as the face material layer and the nonwoven fabric layer mentioned earlier is formed into mats weighing 100˜500 g/m² by heating and melting the thermoplastic resin powder which fills the permeable adhesive resin layer that which adhesively bonds the materials, while assuring permeability and bonding strength throughout the entire

[symbol]

### BEST MODE FOR CARRYING OUT THE INVENTION

The automobile use mats commonly used that are made of vinyl chloride resin or olefin resin in an (bump) emboss form as its anti-slip backing layer, are configured from calcium carbonate filler and vinyl chloride resin or olefin resin mixture for its bumpy surface backing layer that which are adhesively bonded to the surface material layer, and made into a given dimension through the cutting process. These vinyl chloride or olefin resin automobile use mats were used widely due to its good workability and low cost. However, the resin and filling contain calcium carbonate that are heavy weight used as its backing layers, where even with the standard specification sized automobile use mat, they are heavy weighing from 4˜6 Kg/m², and in order to improve fuel efficiency of the automobile, reduction in its weight has been considered.

The automobile use mat 1 in this invention as shown in FIG. 1 is, on its lower surface of its face material layer 2, the fiber on the lower surface of the nonwoven fabric layer 3 which is composed of polypropylene fibers over 1.5 dtex and not more than 30 dtex is heat processed, the fibers on the lower surface of the previously mentioned nonwoven fabric layer is bonded through melting, and integrated by lamination to the nonwoven fabric layer 3 which forms the anti-slip layer 3-1. The nonwoven layer 3 is, as an example like the needle-punch nonwoven fabric, water needle nonwoven fabric, a polypropylene fiber nonwoven material that is 1.0 to 8.0 mm in thickness is appropriate. Material with less than 1.0 mm does not provide sufficient noise absorption features or strength as an automobile use mat, as well as it does not provide enough cushioning properties, and if beyond 8.0 mm, the objective for reducing its weight is lost, as well as it becomes cost ineffective. For best results, a polypropylene fiber nonwoven material that is 2.0 to 5.0 mm in thickness should be used. For the fibers which construct the nonwoven fabric layer 3, if thermoplastics resin fiber such as polyester fiber, polyamide fiber, polypropylene fiber, and acrylic fiber is used, a certain degree of effectiveness can be expected, however polypropylene fibers are most recommended. Polypropylene fibers are, among generic fiber has the lowest melting point, therefore complex surface configuration can be expected and for that reason it is recommended. Additionally, for fineness, the fineness that is over 1.5 dtex and lesser than 30 dtex is desirable. Should fineness be below 1.5 dtex, noises that are within low frequency range are more difficult to be absorbed, as well as it reduces the cushioning properties therefore it is not recommended. For fineness that is over 30 dtex, noises that are within high frequency range are more difficult to be absorbed, therefore it is not recommended either. For best results, among all, polypropylene fiber configuring the nonwoven fabric layers that are within the fineness of 5 dtex to 15 dtex is most recommended.

In addition, within the polypropylene fibers, rather than the fiber with a round cross section, fibers with an atypical cross section otherwise a hollow cross section is desirable. An atypical cross sectioned polypropylene fibers has a greater friction resistance, and for hollow cross sectioned polypropylene fibers when burned, as compared to solid fibers, tends to deform into a more complex form and is desirable as a fiber to configure the anti-slip layer.

FIG. 2 is a picture showing how for the anti-slip layer 3-1, the lower surface of the nonwoven fabric layer composed of polypropylene fiber is burned and bonded through the melting process. FIG. 3 shows how the fibers in the nonwoven fabric layer is before the burn process, and by comparing the two, the changes due to burn processing the surface of the nonwoven fabric layer, these fibers change its configuration into a more complex form, and the fiber surface becomes rough as it solidifies can be identified. This transition to a complex surface structure (roughened configuration, the thickness of the tips on the fibers become thicker and interspersed, sectional bonding through melting, holes form on the sides of the fiber, etc) lead to increasing the entanglement with the floor carpet fibers, creating a greater friction resistance with the floor carpet, and is believed to show an effective anti-slip effect. Furthermore, the nonwoven fabric layer in FIG. 2 and FIG. 3 contains 10 weight % of hollow polypropylene fiber, as well as in order for it to tighten the nonwoven fabric layer, contains 2 weight % of low melting point fiber.

The method for burn the nonwoven fabric layer 3 is, for example, applying fire directly against the nonwoven fabric layer at a temperature of 500˜1200° C. like the gas pile burning equipment, as if to burn off the nap surface, dissolve the fibers on the nonwoven fabric layer surface, and immediately solidifying it. If heated further than the nonwoven fabric layer to the internal section with the flame, the internal section of the nonwoven fabric layer also becomes hard which is not ideal. Additionally, if the flame is too far distant away from the nonwoven fabric layer, the change in configuration does not occur which is also not ideal. In either case, it is necessary to conduct the heat process to the fibers on the surface side of the nonwoven fabric while observing such changes as it occurs.

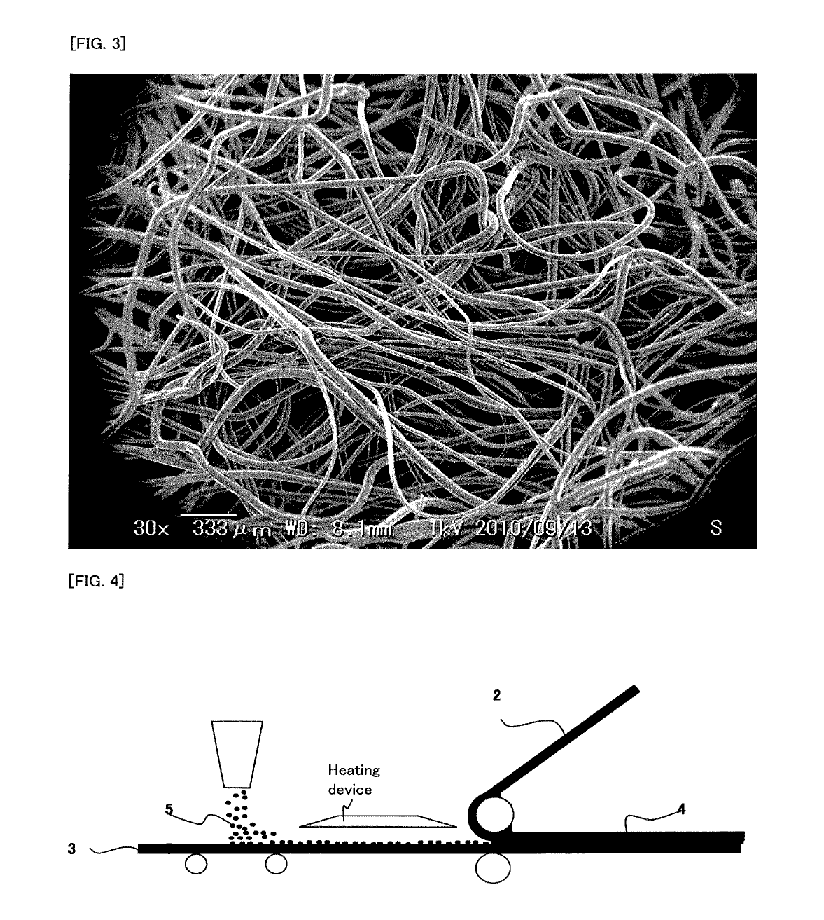

The next step is to produce the base automobile use mat carpet roll by laminating and integrating the surface material 2 with the nonwoven fabric layer 3 that has the anti-slip layer. In order to bond the two materials, for example, as shown in FIG. 4, setting the pile side of the face fabric material 2, the foaming backing resin emulsion 6 is applied on the lower surface of the face material layer, layering it with nonwoven fabric layer 3, drying by adding heat creating the adhesive resin layer 4 with permeability, glue bonding the face fabric material layer 2 with nonwoven fabric layer 3, furnishing with sound absorption and anti-slip features, resulting in a base automobile use mat roll with design to be light in weight.

As for the backing resin 6, a commonly used, for example, SBR latex, Urethane resin, acrylic resin, etc, materials containing calcium carbonate as filler is suitable, apply it to the face material layer using equipment such as a roll coater, layering with nonwoven fabric 3, and dry by applying pressure. During this time, the desired amount of application of the backing resin 6 is 500˜900 g/m² (after drying). When the application amount is lesser than 500 g/m², an appropriate rigidity or bond strength can not be achieved therefore it is not desirable. On the other hand, if it is over 900 g/m², material becomes too hard, where permeability can no longer be provided, as well as the objective to reduce the weight of the entire carpet can not be achieved, and therefore not ideal.

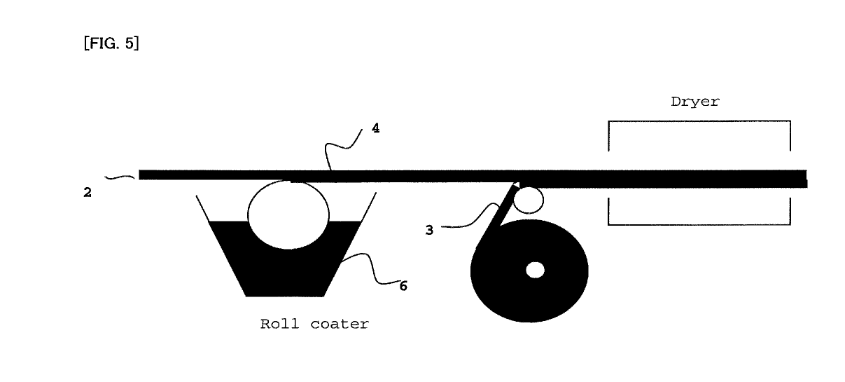

In addition, another optional method in laminating and integrating the surface material 2 with the nonwoven fabric layer 3 that has the anti-slip layer is, for example as shown in FIG. 5, applying thermoplastic resin powder 5 to the nonwoven fabric layer, which is melted by adding heat forming the permeable adhesive resin layer 4, layering the face material 2 with added pressure, furnishing with sound absorption and anti-slip features, resulting in a base automobile use mat roll with design to be light in weight.

In this case, the face fabric material as shown in FIG. 1, the use of carpet with pile (2-2) implanted to the upper surface of the scrim (2-1) as well as pre coated (2-3) on its lower surface. By pre coating, the pile removal strength is secured. As for the carpet, there is no limitation, tufted carpet, woven carpet, knitted carpet, electrodeposited carpet, etc, can be listed as an example for use. Additionally for the building material of face material fabric layer, there is no limitation to scrim or pile, polyester fiber, polyamide fiber, polypropylene fiber, acrylic fiber mixture, otherwise hemp, cotton, wool, etc can be listed as an example for use. From recyclability and safety standpoint, olefin fibers are recommended.

As for the thermo plasticity resin powder 5, although there is no limitation, the suitable is polyethylene resin powder that are 75˜1000 μm particle diameter and application amount of 100˜500 g/m². With particle diameter lesser than 75 μm or above 1000 μm, the suitable permeability can not be obtained therefore it is not desirable. Additionally, in condition where the application amount is below 100 g/m², secure adhesive resin layers can not be formed, as well as if the application amount is above 500 g/m², it is difficult to ensure permeability, and the objective to reduce the weight can not be achieved.

The base automobile use mat rolls formed as described is then cut into its specified mat configuration, the edges of the mats are processed by over locking process, etc, resulting into light weight, noise absorbing and anti-slip featured automobile use mat.

### EXAMPLE

The next section explains about the specific examples on this invention of an automobile mat that has a distinguished anti-slip feature. Furthermore, this invention of an automobile mat that has a distinguished anti-slip feature is not limited to the examples as described in this document.

### Example 1

As the face fabric layer 2, the tufted carpet surface layer (1/10 gauge, pile length 6/3 mm high-low loop, stitching 51/10 cm, Pile yarn 2300 dtex solution dyed polypropylene yarn, weight 670 g/m², scrim polyester spun bond nonwoven fabric 100 g/m², SBR latex emulsion applied with roll coater at 200 g/m² (dry weight), and pre coat processed) as nonwoven fabric layer 3, the needle-punch nonwoven fabric A (fineness 6.7 dtex, fiber length 51 mm polypropylene fiber 80%, fineness 14 dtex, fiber length 64 mm polypropylene fiber 15%, fineness 4.4 dtex low melting point fiber 5%, thickness 4 mm, weight 200 g/m², heat processed on the lower surface using gas fiber burner equipment and surface fibers bonded by melting) on the surface) as adhesive resin layer 4, polyethylene resin powder (particle diameter 100 μm, application amount 300 g/m²) is used and processed by method shown in FIG. 5 to create the base automobile use mat. From this mat, samples were cut, various property tests were conducted, whereas the results are indicated in Table 1. The weight was 1.4 kg/m² which are less than 50% compared to the regular mats with resin or rubber bump embossed configuration. Noise absorption and anti-slip performance were both satisfactory.

### Example 2

As in example 1, besides changing the polyethylene resin powder to particle diameter of 200 μm and application amount to 150 g/m²for the adhesive resin layer 4, all the remaining is maintained the same as example 1, to gain a base automobile use mat. As indicated in Table 1, no detected issues regarding noise absorption and anti-slip performance, furthermore resulted in an automobile use mats that were even lighter in its weight.

### Example 3

In example 1 as nonwoven fabric layer 3, the below needle-punched nonwoven fabric B (fineness 1.7 dtex, fiber length 51 mm polypropylene fiber 70%, fineness 24 dtex, fiber length 64 mm polypropylene fiber 15%, fineness 20 dtex, fiber length 64 mm polypropylene hollow fiber 10%, fineness 4.4 dtex low melting point fiber 5%, thickness 6 mm, weight 250 g/m²) was heat processed under gas fiber burner equipment on the lower surface, and melt bonding the surface fiber) was the only change made to example 1, otherwise all other condition remained the same, to obtain the automobile use mat base roll. Each property test results as indicated in Table 1 were satisfactory.

### Example 4

Using the method in FIG. 4, a similar surface layer 2 (however tufted carpet surface layer that is not pre coated) and nonwoven fabric A used, as adhesive resin layer 4, SBR latex emulsion was applied to surface layer 2 at 550 g/m² (dry weight), nonwoven fabric A layered to and pressure was applied, and dried (for 20 mins at 90° C.). From this, samples were cut, various property tests were conducted, whereas the results are indicated in Table 1. The weight was 1.55 kg/m².

### Example 5

Based on example 4, other than the application of SBR latex emulsion at 890 g/m² (dry weight) to the surface layer 2, the automobile use mat base roll was obtained using the same conditions as in example 4. As indicated in Table 1, no detected issues regarding noise absorption and anti-slip performance furthermore resulted in a light weight automobile use mat roll.

### Comparative Example 1

Based on example 1, as the nonwoven fabric layer 3, other than not heat setting the lower surface of the needle-punched nonwoven fabric using gas fiber burner equipment, the automobile use mat base roll was obtained under the same condition as the example 1. The obtained automobile use mat roll was, similar to that from example 1, however as indicated in Table 2, lacking the anti-slip characteristic.

### Comparative Example 2

Based on example 1, as the nonwoven fabric layer 3, other than changing to the below needle-punched nonwoven fabric C (fineness 1.2 dtex, fiber length 51 mm polypropylene fiber 95%, fineness 4.4 dtex low melting point fiber 5%, thickness 4 mm, weight 300 g/m², heat setting the lower surface using gas fiber burner equipment, and melt bonding the surface fibers), an automobile use mat base roll was obtained under the same condition as the example 1. With the various property tests conducted as shown in Table 2, the anti-slip effect were degraded, and the noise absorption rate for low frequency range was unsatisfactory.

### Comparative Example 3

Based on example 1, as the nonwoven fabric layer 3, other than applying adequate burning to the lower surface side of the needle-punched nonwoven fabric until resin cluster formed, the automobile use mat base roll was obtained under the same condition as the example 1. The obtained automobile use mat base roll was, similar to that from example 1, and had indicated no issues as to its anti-slip effect, however it was inappropriate for use as an automobile use mat due to it being hard and difficult to bend.

### Comparative Example 4

Based on example 1, as the nonwoven fabric layer 3, other than changing the below needle-punched nonwoven fabric D (fineness 35 dtex, fiber length 51 mm polypropylene fiber 100%, thickness 4 mm, weight 300 g/m² heat setting the lower surface using gas fiber burner equipment, and melt bonding the surface fibers), an automobile use mat base roll was obtained under the same condition as the example 1. With the various property tests conducted as shown in Table 2, the noise absorption rate for high frequency range was not up to expectation.

### Comparative Example 5

Based on example 1, as the nonwoven fabric layer 3, other than changing the below needle-punched nonwoven fabric E (fineness 6.7 dtex, fiber length 51 mm polyester fiber 80%, fineness 14 dtex, fiber length 64 mm polypropylene fiber 15%, fineness 4.4 dtex melting fiber 5%, thickness 4 mm, weight 200 g/m² heat setting the lower surface using gas fiber burner equipment, and melt bonding the surface fibers), an automobile use mat base roll was obtained under the same condition as the example 1. With the various property tests conducted as shown in Table 2, the anti-slip effect was not up to expectation.

### Measuring And Evaluating Noise Absorption Property

In compliance with the ASTEM E1050 Vertical Entry Sound Absorption Rate Measurement Method, the sound absorption rate at 1000 Hz, and 2000 Hz were measured, where absorption rate of above 0.150 was needed to pass the test.

### Measuring And Evaluating Anti-slip Effect

Using the samples cut from the automobile use base mat (100 mm×140 mm), the nonwoven fabric layer 3 (anti-slip layer 3-1) was directly placed over the conventional needle-punched carpet that are installed in the automobile floor so that it touch. Followed by, adding 1 kg of weight over the surface material layer of the sample, and then pulling the sample in horizontal direction against the needle-punched nonwoven fabric at the speed of 100 mm/min, in the meanwhile measuring the friction resistance force of when the sample slid over. Furthermore, this friction resistance force was measured 5 times, and the result is based on the average, presuming the actual circumstance of when the automobile use mat was placed inside the automobile, the automobile use mat was determined to be eminent in its anti-slip effect when the friction resistance force was above 50N.

TABLE 1

| | Example 1 | Example 2 | Example 3 | Example 4 | Example 5 |
|---|---|---|---|---|---|
| Surface | With Pre | With Pre | With Pre | Without | Without |
| Layer | Coating | Coating | Coating | Pre Coating | Pre Coating |
| Nonwoven | A Heat | A Heat | B Heat | A Heat | A Heat |
| Fabric Layer | Processed | Processed | Processed | Processed | Processed |
| Adhesive | 100 μ m 300 g | 200 μ m 150 g | 100 μ m 300 g | SBR 550 g | SBR 890 g |
| Resin Layer | | | | | |
| (Particle | | | | | |
| Diameter/ | | | | | |
| Application | | | | | |
| Amount) | | | | | |
| Weight | 1.4 | 1.2 | 1.5 | 1.65 | 2 |
| (Kg/m²) | | | | | |
| Noise | 0.16 | 0.15 | 0.18 | 0.16 | 0.16 |
| Absorption | | | | | |
| Rate 1000 Hz | | | | | |
| 2000 Hz | 0.31 | 0.2 | 0.30 | 0.32 | 0.33 |
| Anti-slip | 52 | 51 | 55 | 52.2 | 52.5 |
| Performance (N) | | | | | |

TABLE 2

| | Comparative | Comparative | Comparative | Comparative | Comparative |
|---|---|---|---|---|---|
| | Example 1 | Example 2 | Example 3 | Example 4 | Example 5 |
| Surface | With Pre | With Pre | With Pre | With Pre | With Pre |
| Layer | Coating | Coating | Coating | Coating | Coating |
| Nonwoven | A Non Heat | C Heat | A Heat | D Heat | E Heat |
| Fabric Layer | Processed | Processed | Processed | Processed | Processed |
| Adhesive | 100 μ m 300 g | 100 μ m 300 g | 100 μ m 300 g | 100 μ m 300 g | 100 μ m 300 g |
| Resin Layer | | | | | |
| (Particle | | | | | |
| Diameter/ | | | | | |
| Application | | | | | |
| Amount) | | | | | |
| Weight | 1.4 | 1.4 | 1.4 | 1.55 | 1.2 |
| (Kg/m²) | | | | | |
| Noise | 0.15 | 0.12 | 0.15 | 0.15 | 0.2 |
| Absorption | | | | | |
| Rate 1000 Hz | | | | | |
| 2000 Hz | 0.31 | 0.33 | 0.33 | 0.12 | 0.3 |
| Anti-slip | 14 | 52.5 | 52 | 52.5 | 24 |
| Performance (N) | | | | | |

### BRIEF DESCRIPTION OF DRAWING

[FIG. 1] A diagrammatic illustration of the automobile use mat which is one of the operational configuration relating to this invention.

[FIG. 2] A photograph displaying how the fiber in the nonwoven fabric layer in the automobile use mat which is one of the operational configuration relating to this invention, is heat processed and melt bonded.

[FIG. 3] A photograph displaying how the fibers of the nonwoven fabric layer in the automobile use mat which is one of the operational configuration relating to this invention is prior to the heat process.

[FIG. 4] A diagrammatic illustration on the manufacturing process of the mat rolls of the automobile use mat which is one of the operational configuration relating to this invention.

[FIG. 5] A diagrammatic illustration on the manufacturing process of the mat rolls of the automobile use mat which is one of the operational configuration relating to this invention.

### INDUSTRIAL APPLICABILITY

This invention is, by heat processing the fibers on the polypropylene nonwoven fabric, forms anti-slip layers from the changes in fiber configuration, adding rigidity to the fabric, and as a replacement to the conventional backing resin for its resin layer, allows dramatic reduction in its weight being so light weight. Not limiting to only automobile use, this can be widely used as an effective weight reduction technology by layering to floor coverings such as carpet, mat, and rugs made of fibers.

### DESCRIPTION OF THE REFERENCE NUMBERS

1 . . . Automobile Use Mat
2 . . . Face Fabric Material Layer
2-1 . . . Scrim
2-2 . . . Pile
2-3 . . . Pre Coating
3 . . . Nonwoven Fabric Layer
3-1 . . . Anti-slip Layer
4 . . . Adhesive Resin Layer
5 . . . Thermoplastic Resin Powder
6 . . . Backing Resin

1. An automobile use mat product in which its face material layer is laminate incorporated on its lower side to the nonwoven fabric layer, and the nonwoven fabric mentioned earlier is formed from polypropylene fiber over 1.5 dtex and no more than 30 dtex, as well as the lower side fiber of the nonwoven fabric layer previously mentioned is burned, where the fiber bond/fibers bonds together from melting, and this nonwoven layer fiber configuration is thicker at its top most edge compared to the fiber cross section, that create an anti-slip effect. This automobile use mat product is characterized by its distinguished anti-slip feature.

2. An automobile use mat product as recited in claim 1, with a distinguished anti-slip feature containing hollow fiber within the polypropylene fiber mentioned earlier.

3. An automobile use mat product as recited in claim 1, with a distinguished anti-slip feature manufactured from carpet material with pile punched to the scrim within the face fabric material layer mentioned earlier, as well as in its face material layer and nonwoven fabric layer mentioned earlier, is formed into a 500-900 g/m² weight mat (after drying) from backing resin which fills the permeable adhesive resin layer that which adhesively bonds materials.

4. An automobile use mat product as recited in claim 1, with a distinguished anti-slip feature manufactured from carpet material with pile punched to the scrim and for the face fabric layer mentioned earlier, a pre-coating process is applied to its lower surface of the scrim. This mat contains face material layer and nonwoven fabric layer earlier mentioned, and is formed into 100-500 g/m² weight mat from melting the thermoplastic resin powder by applying heat which fills the permeable adhesive resin layer that which adhesively bonds materials.

5. An automobile use mat product as recited in claim 2, with a distinguished anti-slip feature manufactured from carpet material with pile punched to the scrim within the face fabric material layer mentioned earlier, as well as in its face material layer and nonwoven fabric layer mentioned earlier, is formed into a 500-900g/m² weight mat (after drying) from backing resin which fills the permeable adhesive resin layer that which adhesively bonds materials.

6. An automobile use mat product as recited in claim 2, with a distinguished anti-slip feature manufactured from carpet material with pile punched to the scrim and for the face fabric layer mentioned earlier, a pre-coating process is applied to its lower surface of the scrim. This mat contains face material layer and nonwoven fabric layer earlier mentioned, and is formed into 100-500 g/m² weight mat from melting the thermoplastic resin powder by applying heat which fills the permeable adhesive resin layer that which adhesively bonds materials.
